(19) United States
(12) Patent Application Publication
(10) Pub. No.: US 2012/0036870 A1
(43) Pub. Date: Feb. 16, 2012

(54) Method of both cooling and maintaining the uniform temperature of an extended object

(76) Inventors: Daniel Woojung Kwon, Arlington, VA (US); Raymond J. Sedwick, College Park, MD (US); David W. Miller, Cambridge, MA (US)

(21) Appl. No.: 12/806,449

(22) Filed: Aug. 13, 2010

(51) Int. Cl. F25B 19/00; F28D 15/00; F17C 13/00

(52) U.S. Cl. 62/51.1; 220/560.12; 165/104.28

(57) ABSTRACT

A general method of cooling and maintaining the uniform temperature of an extended structure is provided with specific application discussed of keeping a superconducting coil at cryogenic temperatures in the presence of external heat loads that may be variable in space and time. The approach embeds the structure to be cooled (208) into the vapor space (108) of a heat pipe assembly (202), which consists of an outer wall (116), a fluid wicking mechanism (110, 114), thermal insulation (118) and a mechanism for heat extraction, such as the cold tip (206) of a cryocooler (204).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

This invention pertains to the cryogenic thermal control of large structures, with a specific example being to uniformly maintain coils of superconducting wire at cryogenic temperatures.

2. Prior and Related Art

Superconducting materials (SCMs) are finding ever-increasing applications in a variety of technology areas. However, at the present time their use depends on the ability to maintain them at cryogenic temperatures, since they need refrigeration to overcome two sources of heat loading. The first is any heat leaking into the system from the surrounding environment. The second is any internal heat generation in the device.

For small volumes or surfaces, their temperatures can be maintained using cryocoolers by connecting the cold tip of the cryocooler directly to the object. However, this is not effective if the desire is to cool an extended object that is much larger than the cold tip of the cryocooler.

The most common method of cooling larger structures for limited lifetimes is by immersing the object in a liquid cryogen by which heat is extracted through evaporation of the liquid. A common method of achieving a cryogenic isothermal bath is to use liquid nitrogen (LN2) or liquid helium (LHe). A limitation of using cryogens is that they have a narrow operating temperature that is restricted by the cost and suitability of available cryogens. More importantly, for space applications, the amount of cryogen available limits the lifetime of the superconducting device. Once the cryogen has evaporated it must be replenished making it a life-limiting consumable. The volume and mass of the required liquid cryogen is also a disadvantage.

Another method for cooling superconducting materials is to integrate the cryogen bath with a closed cycle refrigeration system (such as a cryocooler) to re-condense the cryogen to its liquid phase. This approach is typically referred to as a ‘cryostat’ and is similar to the methods described in U.S. Pat. Nos. 6,622,494, 6,640,552, and 7,263,841. In the '494 and '552 patents a method of passively circulating the working fluid to cool the superconductor is not described. In the '841 patent, a heat pipe is placed externally to the superconductor.

A heat pipe is a device used to transport heat from one location to another. Heat pipes work using two-phase flow properties of a working fluid and in doing so act like a material with very high thermal conductivity. The length of the pipe is the effective distance that heat is transported. Cryogenic heat pipes have been described in U.S. Pat. Nos. 5,555,914 and 6,173,761. However, in both patents, the object to be cooled is external to the heat pipe.

In the case of a current-carrying superconducting material, once it is cooled to below its transition temperature it will generate no heat. However, if the critical current is exceeded the wire may quench and start to rapidly heat. Another disadvantage of the cryogenic bath or the cryostat is that while the liquid cryogen can quickly absorb this heat, the resulting rapid boiling may cause an over-pressuring of the system. The system must either be vented, which may result in a premature loss of liquid cryogen, or if the pressurization is too rapid the containment vessel could rupture or explode.

Another disadvantage of the cryogen bath and the cryostat occurs in the event that either is being used to cool a superconductor that is carrying a time varying current. The electric field inside the liquid cryogen will repeatedly re-polarize the cryogen causing a dielectric loss. This loss can be as extensive as the resistive losses that have been removed by using the superconductor in the first place, so they can represent substantial losses.

### BACKGROUND OF THE INVENTION—OBJECTS AND ADVANTAGES

An increasing number of space missions are considering the use of multiple spacecraft flying in close proximity to replace traditional large monolithic space systems. Formation flying space interferometers are an example of this application. A method of providing actuation for these formation flight spacecraft is the use of electromagnetic forces and reactions wheels. This method has several advantages over traditional propellant-based thrusters such as the replacement of consumables to extend mission lifetime, elimination of impinging thruster plumes, and the enabling of high ΔV formation flight missions. A large steerable electromagnetic (EM) dipole can be created by running current through three orthogonal coils of wire. The EM dipole creates coupled forces and torques on nearby satellites with electromagnetic formation flight coils. Using a reaction wheel, one can decouple the forces and torques to provide all the necessary actuation in relative degrees of freedom for a formation flight array.

Another application is the resonant inductive coupling of power or signals between two tuned coils. In this application, the primary coil is driven directly by a power source at its resonant frequency, and mutual coupling between the resonant primary and secondary coils causes a transfer of energy between them that can be used to power a load at the secondary or demodulated to reveal an encoded signal. The inductive coupling has the advantage of substantially less attenuation than electromagnetic radiation, making it feasible that such transmissions could be made through buildings, into caves and mines and undersea as well.

The operation of these technologies at significant distances requires that the electrical currents are high, and therefore reasonable efficiency requires that the Ohmic losses are as low as possible, necessitating the use of superconducting wire. These large superconducting coils cannot be cooled using a cryocooler alone, and the use of a cryostat has the disadvantages listed in the last section.

The current invention avoids the many disadvantages of the prior art by embedding the superconducting wire into the vapor space of a heat pipe. A heat pipe uses the evaporation and condensation of a two-phase fluid to efficiently transport heat. The liquid form of the working fluid is typically wicked by capillary action from regions of condensation (cooling) to regions of evaporation (heating). The gas form of the working fluid then convectively transports heat from the regions of evaporation to the regions of condensation. The rapid transport of gas by convection allows for substantially higher heat flows than can be achieved by even the best conducting materials.

Having the convective cooling with the vapor phase offers much of the same advantage of liquid phase cryogen contact. However, quenching with a vapor cooled SCM will not result in an increase in vapor pressure and is therefore a much more easily recoverable fault.

In addition to the Ohmic losses, the range and efficiency of the resonant inductive system is greatly extended by reducing the other parasitic coil losses that result from an oscillatory signal. These additional losses are dielectric and radiative. Radiative losses can be reduced by operating at lower frequencies. Dielectric losses can be eliminated by avoiding the use of a dielectric in the construction of the coil, as discussed in Sedwick, R. J., “Long Range Inductive Power Transfer with Superconducting Oscillators,” Annals of Physics, 325, 2, pp 287-299, February (2010).

An additional problem with using a cryostat to cool these coils is that the cryogenic liquid between the wires of the coils acts as a dielectric and results in substantial power loss and subsequent boiling of the liquid cryogen. Using a vapor phase cryogen provides the required cooling for the wires, but offers a negligible dielectric loss and does not result in boiling of the cryogen and the associated problems.

Specifically the current invention would have the following objects and advantages:
(a) Provides a method to cool extended structures to a highly uniform temperature
(b) Provides a method to cryogenically cool extended structures such as coils of superconducting wires that cannot be cooled with only a single cryocooler
(c) Provides a cooling method that uses far less mass and volume of liquid cryogen than would be used by a cryostat
(d) Provides a cooling method that will not overpressure as a result of sudden heat production from the structure, such as the quenching of a superconducting coil
(e) Provides a cooling method that only requires a single point of heat extraction such as can be provided by a single cryocooler

Further objects and advantages of this invention are to provide a cooling method that can effectively reject external heat sources, and do so even in the event these sources are varying either spatially or in time. Still further objects and advantages will become apparent from a consideration of the drawings and ensuing description.

### SUMMARY

In accordance with the present invention, an extended structure such as a large superconducting coil is cooled to a uniform cryogenic temperature by embedding it in the vapor space of a heat pipe. The uniform temperature of the structure may be maintained in the presence of spatially and temporally varying external heat sources. The invention uses a much smaller mass and volume of cryogen than a cryostat, and requires only a single point of heat extraction. Unlike a cryostat, an unintentional increase in heat generation by the cooled structure will not cause rapid evaporation of the cryogen, thus offering substantial protection against over-pressuring that could result in loss of cryogen or explosive damage.

### DRAWINGS—FIGURES

FIG. 1 shows a typical linear heat pipe (prior art)

FIG. 2 shows a closed loop heat pipe with the object to be cooled embedded in the vapor space

DRAWINGS-REFERENCE NUMERALS

| | |
|---|---|
| 102 | object to be cooled |
| 104 | cold reservoir |
| 106 | heat pipe assembly |
| 108 | vapor space of heat pipe |
| 110 | inner screen mesh |
| 112 | liquid layer |
| 114 | outer screen mesh |
| 116 | heat pipe casing |
| 118 | thermal insulation |
| 202 | closed heat pipe |
| 204 | cryocooler |
| 206 | cold tip of cryocooler |
| 208 | object to be cooled |
| 302 | heat flux |

### DETAILED DESCRIPTION—PREFERRED EMBODIMENT—FIGS.

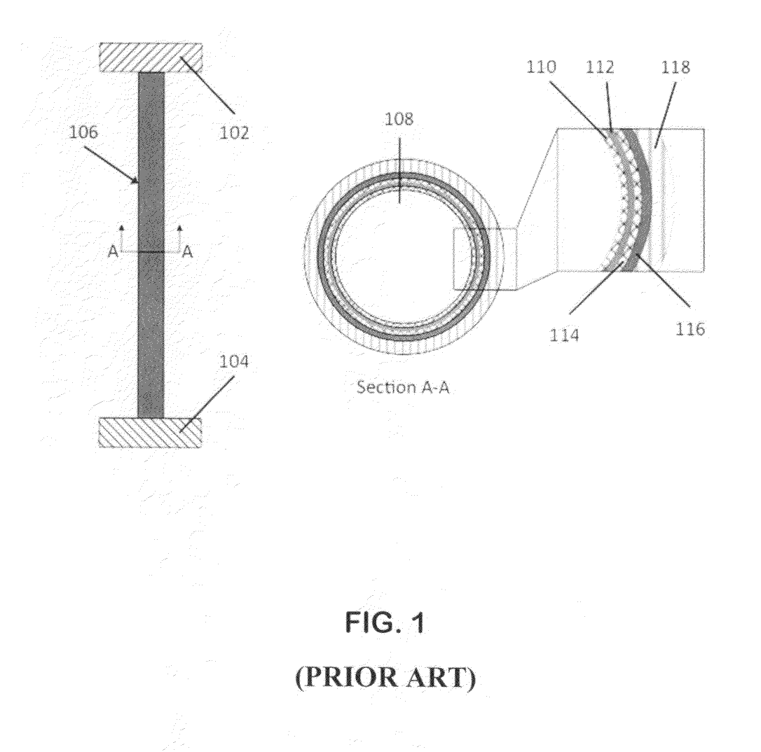

FIG. 1 shows the prior art of a typical heat pipe assembly 106 conducting heat between an object to be cooled 102 and a cold reservoir 104. A cross-section (A-A) shows one particular embodiment of a typical heat pipe, consisting of an inner vapor space 108 and a number of layers at the wall, shown in the inset. This particular embodiment shows an inner mesh grid 110, a liquid layer of the working fluid 112, an outer mesh grid 114, the wall of the heat pipe 116 and an outer layer of thermal insulation 118.

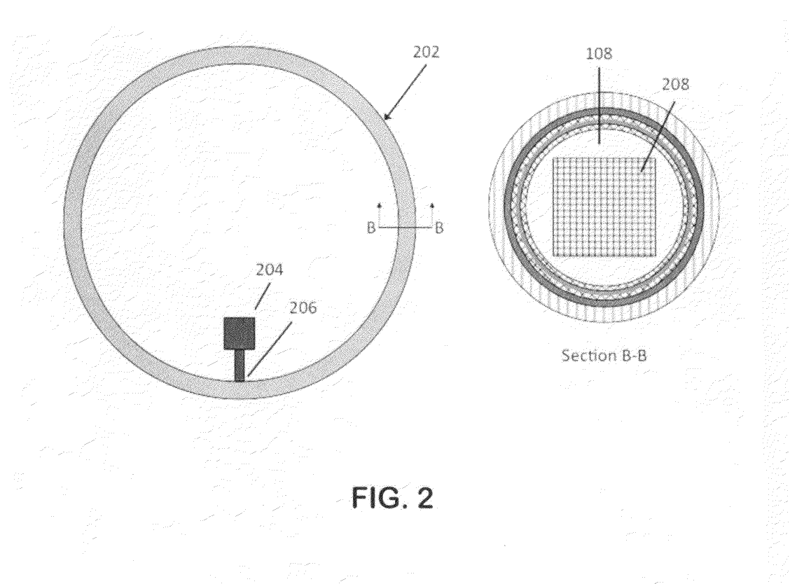

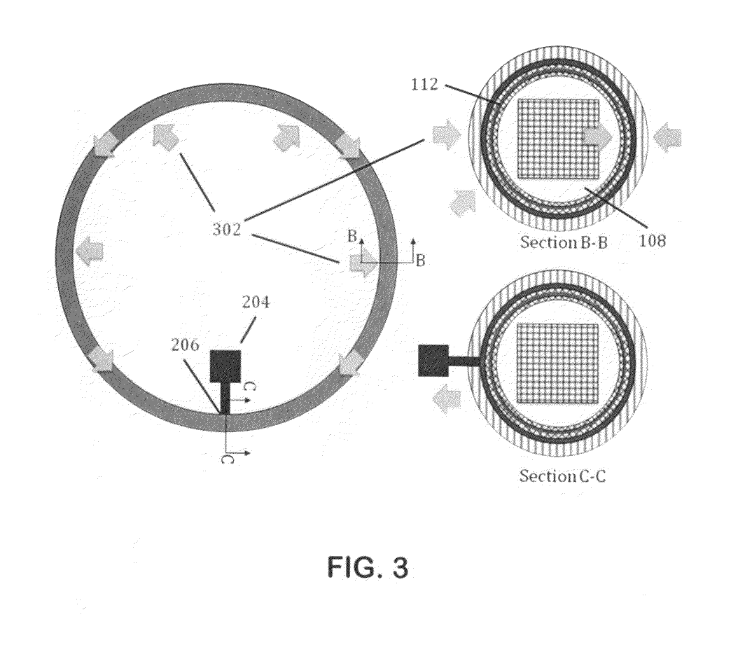

FIG. 2 shows a preferred embodiment of the current invention, consisting of a closed heat pipe 202 and a cryocooler 204 with its cold tip 206 in contact with the wall of the heat pipe at a single location, which will be the coldest point within the heat pipe. Cross-section B-B shows a similar heat pipe embodiment as in FIG. 1, however the object to be cooled 208 is shown embedded within the vapor space 108 of the heat pipe. The wall layers are the same as identified in FIG. 1.

### OPERATION—PREFERRED EMBODIMENT—FIGS.

FIG. 3 shows the operation of the preferred embodiment. All of the heavy arrows, some of which are labeled 302 represent the flow of heat in the system. Heat is seen to flow from the environment into the heat pipe as well as from the object being cooled into the heat pipe. A typical heat influx cross-section B-B is shown. As heat flows into the system, liquid 112 evaporates into the vapor space of the heat pipe 108. This vapor then travels rapidly around the circumference of the pipe to cross-section A-A, where the wall is held at a low temperature by the cold tip 206 of the cryocooler 204. At this point the vapor condenses onto the wall where it is then wicked back around to areas of higher temperature by the capillary action of the meshes 106 and 110. The vapor in the vapor space 108 is in continuous contact with the object being cooled 208 so as to extract heat from it and deposit this heat at cross-section B-B.

### CONCLUSION, RAMIFICATIONS, AND SCOPE

Accordingly, the reader will see that the thermal control system described here is superior to previous methods because it offers the following advantages:
Complete encapsulation of the structure in an isothermal vapor, unlike the single cryocooler tip or an externally mounted heat pipe
Use of a vapor phase in contact with the structure rather than a liquid phase to reduce the amount of cryogen that is needed, as compared to a cryostat
Use of the vapor phase to eliminate the possibility of rapid boiling and subsequent catastrophic failure that could result from quenching in the case of a current-carrying superconducting coil
Need for only a single point of heat extraction, as can be provided by a single cryocooler, due to the rapid distribution of heat through the system

Although the description above contains many specificities, these should not be construed as limiting the scope of the invention but as merely providing illustrations of some of the presently preferred embodiments of this invention.

For example, while screen mesh is shown used as the method for wicking the liquid from saturate regions to regions of evaporation, other methods such as grooved channels or rough surface finishes can be used. As another example, only two layers of mesh have been shown, however multiple layers can be used with one or more layers of varying mesh size to improve the wicking characteristics. Combinations of meshes and grooves can also be used.

While the focus of the preferred embodiment is on cryogenic thermal control, the invention described here can be used over a variety of temperature ranges, provided a working fluid can be found that is a saturated vapor within the range of temperatures and pressures that are appropriate.

The method used for removing heat at the low temperature end of the system could be any device or thermal mass that will absorb heat at the desired temperature. As an example, a secondary flow of a fluid in some conduit that is in thermal contact with the heat pipe (such as another cryogen) could be used. For non-cryogenic operations, this fluid would simply need to remain flowing (a liquid or gas) at the desired temperature.

The type of insulation used in the preferred embodiment is left unspecified, since any appropriate means of insulation that is sufficient to sufficiently limit the flow of heat into the system may be used. As an example, for applications in space this may be a form of multi-layer insulation (MLI) consisting of alternating layers of Mylar (™-Dupont) and some webbing to provide a vacuum gap.

While the preferred embodiment discusses the cooling of a superconductor, any structure that must be maintained at a uniform temperature that is below its surrounding environmental equilibrium temperature can be cooled and kept at this uniform temperature provided the insulation can limit the heat flow into the system to below what can be removed by the available heat removal mechanism.

Thus the scope of the invention should be determined by the appended claims and their legal equivalents, rather than by the examples given.

We claim:

1. A method of both cooling and maintaining an extended object below a desired temperature by immersing said object inside a pressure vessel that contains a means for passively circulating a working fluid.

2. The method of claim 1, wherein said fluid is saturated and a means is provided to keep the liquid phase of the fluid out of contact with said object and near the walls of said vessel.

3. The method of claim 2, wherein the means of keeping said liquid phase near said walls is one or more layers of wire mesh.

4. The method of claim 2, wherein said fluid is cryogenic.

5. The method of claim 1, wherein a means is provided to thermally insulate said vessel from the surrounding environment

6. The method of claim 5, wherein the means of providing insulation is Multi-Layer Insulation (MLI) or a vacuum gap.

7. The method of claim 1, wherein a means is provided to externally extract heat from said vessel at one or more locations.

8. The method of claim 4, wherein the means of extracting heat is a cryocooler

9. The method of claim 1, wherein the means of providing said circulation is by providing a means for capillary pumping

10. The method of claim 9, wherein the means of providing capillary pumping is selected from the group consisting of one or more wire mesh, grooves or a rough surface.
